(19) United States
(12) Patent Application Publication
(10) Pub. No.: US 2009/0009512 A1
(43) Pub. Date: Jan. 8, 2009

(54) IMAGING SYSTEM

(75) Inventors: Damien Jean-Jacques Dolimier, Orleans (FR); Chuan Zheng, Bedford, MA (US); Ivan Salgo, Pelham, MA (US)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(73) Assignee: KONINKLIJKE PHILIPS ELECTRONICS N.V., EINDHOVEN (NL)

(21) Appl. No.: 11/573,802

(22) PCT Filed: Aug. 26, 2005
(86) PCT No.: PCT/IB2005/052805

§ 371 Date: Sep. 12, 2008

Related U.S. Application Data
(60) Provisional application No. 60/605,807, filed on Aug. 31, 2004.

(51) Int. Cl. G06T 17/00

(52) U.S. Cl. 345/420; 382/128

(57) ABSTRACT

The present invention relates to an imaging system for displaying a structure of temporally changing configuration. The imaging system comprises a display rendering means which processes the image data representative of the structure, renders a display representative of the structure and a presents a display panel of key data indicia which relates to the key data of the structure. The data indicia is targeted within a two stage process, which first causes the relevant computer generated trace image related to the data indicium to be superposed upon the relevant ultrasound image. The second stage provides the option of selecting the data indicium to further reveal information about the structure. Such an interaction provides all the data related to a key measurement and not just the end result, without cluttering the display images by displaying all the image data simultaneously.

### FIELD OF THE INVENTION

The present invention relates to an imaging system and particularly to an imaging system for displaying image data of a structure of temporally changing configuration.

### BACKGROUND OF THE INVENTION

In certain situations it useful to relate images of a structure to measurements or other data specific to that structure, particularly in circumstances where the configuration of the structure changes over time. Particularly in medical systems, in which internal organs are monitored, it is useful to facilitate monitoring of such relationships. For example, the stretching of the Left Ventricle (LV) during the cardiac cycle is known to be related to cardiac health. Imaging technology enables static volume (3D) images and dynamic volume (4D) images to be generated. Cardiac imaging systems such as Ultrasound, CT or MRI have been developed to image the LV during the cardiac cycle.

3D ultrasound image data acquisition systems enable the collection, typically for post processing and image rendering, of 3D volume image data. The image data may be displayed showing planar ‘slices’ through the volume or as a 3D image. Typically orthogonal slice planes are displayed, usually at separate but adjacent image panes comprising the display. A computer enhanced image of the LV border may be superposed on the ‘slice’ planes and a 3D generated mesh of the LV may be superposed at the 3D image pane. Certain characteristic volume area and distance measurements are useful to the observer such as End Diastole Volume (EDV), End Systole Volume (ESV), and 4 & 2 chamber Diastole and Systole area and length. Ejection Fraction (EF) is also a characteristic measurement. In general, measurement data may relate to volumes, areas, lengths or other physiological variables of the structure.

A useful modality of visualisation has now been devised.

### SUMMARY OF THE INVENTION

It is an object of the present invention to provide a modality of visualisation enabling a system user to interact with and/or observe an image display providing useful correlation between image data relating to the structure and characteristic measurements relating to the structure.

According to a first aspect, the present invention provides an imaging system for displaying image data representative of a structure of temporally changing configuration, the system comprising display rendering means for processing data representative of the structure configuration and rendering a display comprising:
a structure image representative of the structure; and,
a plurality of key data indicia, relating to key data of the structure;
the system operating such that user targeting of a key data indicium causes the structure image to display a highlight image of the structure related to the targeted indicium.

According to a second aspect, the invention provides a method of rendering image data representative of a structure, the method comprising:
processing data representative of the configuration of the structure;
rendering a display comprising a structure image representative of the structure and, a plurality of key data indicia relating to key data of the structure;
targeting key data indicium causing the structure image to display a highlight image of the structure related to the targeted indicium.

The present invention enables the ‘labelling’ of key image views without the need for labels or leader lines being present on the structure image. This results in a less cluttered image and aids in user comprehension of the image on view.

It is preferred that the highlighted image comprises a computer generated border, trace, 3D volume, or slice view relating to the key data indicium targeted. The highlight image is beneficially visually enhanced or distinguished with respect to the underlaying structure image view.

Preferably, plural mode targeting of the key data indicia is provided for. The mode of the structure display being dependent upon the mode of targeting the respective key data indicium. In a preferred realisation, a first mode of targeting is to position a display view cursor over the key data indicium, and a second mode of targeting is to provide a use input (such as a mouse click or keypad press) whilst the cursor is in position over the indicium. For example, when the user positions the cursor over the indicium EDV RESULT, the corresponding end diastole volume image trace or border is highlighted; if the user then mouse clicks on EDV RESULT indicium the corresponding volume and plane image is displayed. This is found to be a useful way for the user to interact and manipulate the image views.

It is preferred that the display comprises image view panes displaying different image views, different image view panes displaying orthogonal slice plane views and further pane displaying a 3D volume view.

Desirably, the structure image view portion of the display is distinct or demarked from the key data indicia portion of the display. The key data indicia may beneficially be presented in a key data indicia panel or pane displayed alongside the structure image portion of the display. The key data indicia may be presented in a margin or border of the display.

The key data indicia may be icons or other user targetable labels or descriptors.

In one embodiment, the system includes means for acquiring the image data representative of the structure. The system may include ultrasound apparatus for acquiring the image data.

According to a further aspect, the invention provides a computer program product comprising a set of instructions for carrying out a method according to the invention.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a schematic representation of the data acquisition system, and

FIG. 2 is an ultrasound display of the left ventricle from different perspectives.

### DETAILED DESCRIPTION OF THE INVENTION

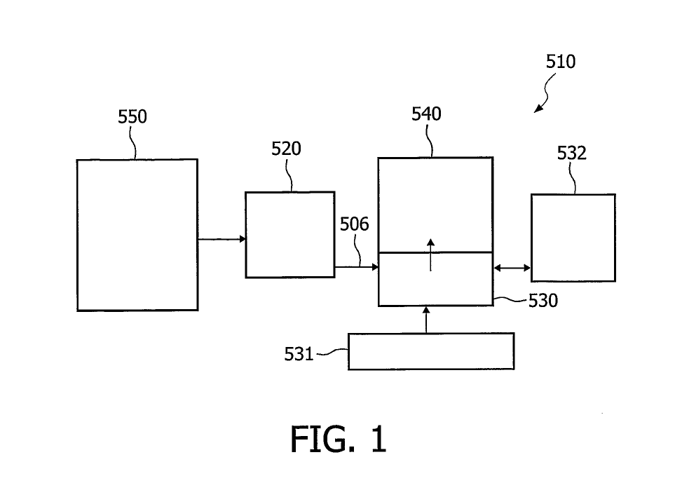

In accordance with the present invention and referring to FIG. 1, data acquisition may be accomplished via a 3D echocardiography examination system, comprising means for acquiring 3D volume digital data and is associated with a digital processing system for processing the acquired 3D volume data. The examination system 550 shown in FIG. 1 comprises means for providing image data to the processing system which has at least one output 506 to provide image data to display and/or storage means 530,540. The display and storage means may respectively be the screen and memory of a workstation 510. The workstation 510 may also comprise a keyboard 531 and a mouse 532.

The image processing system 520 may be a suitably programmed computer of a workstation 510, or a special purpose processor having circuit means such as filters, logic operators and memories, that are arranged to perform the functions of the method steps according to the invention. The processing system 520 may use a computer program product having program instructions to be executed by the computing means of the processing system 520 in order to carry out the method steps. The data processing system, display and/or storage means may be located remotely from the data acquisition means of the system.

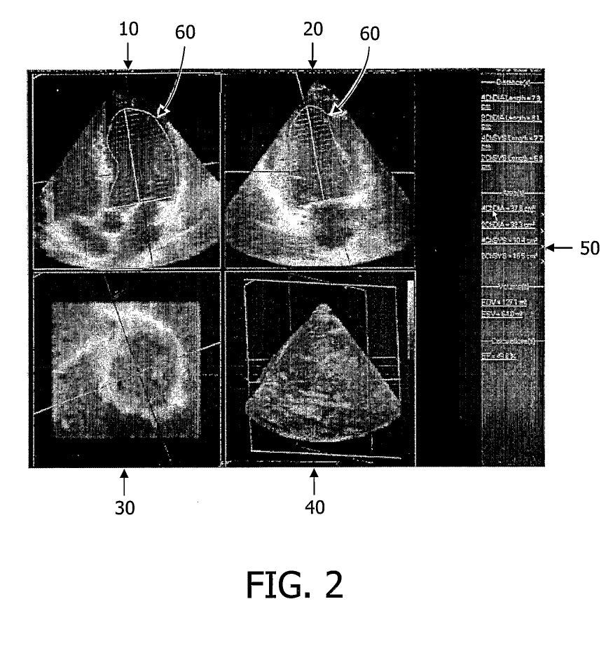

Following the data acquisition stage, the 3D volume data is processed to generate image data of the structure, for example, the left ventricle (LV), which is then presented to the user in a series of 2D cross-sectional image slices from orthogonal viewpoints around the LV, as shown in display panes 10, 20 and 30 of FIG. 2, together with a 3D image of the structure as shown in pane 40. In addition, the data is processed to hold key information such as distances, areas, volumes and masses etc of the LV relating to the configuration of the LV at different times in the cardiac cycle.

In prior art techniques information about each image view has been displayed on the image display itself which renders the image and information less comprehensible. Furthermore, it is difficult to associate a particular set of information to the relevant image view. Thus, there is a need to improve user interaction with a system to observe a structure image and data relating to a structure image.

In accordance with the present invention, the system provides an image of the structure and a plurality of key indicia relating to the key data of the structure. The display provides the image panes 10, 20, 30, 40 separated from the key data pertaining to the image panes. With regards to the display shown in FIG. 2, the key indicia are presented to the user in a panel 50 that is located within a margin of the display.

The data indicia are interacted within a targeting process which involves two stages or modes. In the first stage, the cursor is moved over the relevant icon or descriptor data indicia within the display panel 50, with the result that the ultrasound image 10, 20, 30, to which the data indicium relates becomes superposed with a computer generated trace that is constructed from the image data relating to the data indicium. If that particular data indicium is then further selected in a second stage, for example, by pressing the mouse button whilst the cursor is over the data indicium, information pertaining to the image such as area and volume is displayed.

For example, when a user highlights the 4 chamber diastole (4ChDia) data, the relevant trace image 60 is highlighted on the ultrasound image. Alternatively, if the user highlights the end diastole volume (EDV) result, the corresponding trace is highlighted and if the user then selects the result the corresponding volume and plane is displayed. Similarly, if the end fraction (EF) indicium is highlighted, the 2 end diastole areas are displayed and if the EF indicium is further selected, the 2 end systole areas are displayed.

Thus, it is appreciated that such an interaction provides the user with the whole story about a given measurement and not just the end result.

The invention has primarily been described in relation to imaging the LV during the cardiac cycle. The skilled addressee will however readily appreciate that the invention can be applied to imaging other cardiac structures (such as the right ventricle or left atrium) or indeed other structures or organs.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An imaging system for displaying image data representative of a structure of temporally changing configuration, the system comprising display rendering means for processing data representative of the structure configuration and rendering a display comprising:
a structure image representative of the structure; and,
a plurality of key data indicia, relating to key data of the structure;
the system operating such that user targeting of a key data indicium causes the structure image to display a highlight image of the structure related to the targeted indicium.

2. An imaging system according to claim 1, wherein the highlight image comprises a computer generated border, trace, 3D volume, or slice view relating to the key data indicium targeted.

3. An imaging system according to claim 1, wherein the structure is the heart Left Ventricle (LV) and the key data indicia relate to characteristic key measurements related to the LV.

4. An imaging system according to claim 3, wherein the key data indicia relate to LV area and or distance and/or volume measurement.

5. An imaging system according to claim 1, wherein the highlight image is visually enhanced or distinguished with respect to the underlaying structure image view.

6. An imaging system according to claim 1, wherein plural mode targeting of the key data indicia is provided for, the mode of the structure display being dependent upon the mode of targeting the respective key data indicium.

7. An imaging system according to claim 6, wherein a first mode of targeting is to position a display viewed cursor over the key data indicium, and a second mode of targeting is to provide a use input (such as a mouse click or keypad press) whilst the cursor is in position over the indicium.

8. An imaging system according to claim 1, wherein the display comprises image view panes displaying different image views, different image view panes displaying orthogonal slice plane views and further pane displaying a 3D volume view.

9. An imaging system according to claim 1, wherein the structure image view portion of the display is distinct or demarked from the key data indicia portion of the display.

10. An imaging system according to claim 9, wherein the key data indicia is presented in a key data indicia panel or pane displayed alongside the structure image portion of the display.

11. An imaging system according to claim 1, including means for acquiring the image data representative of the structure.

12. An imaging system according to claim 11, including ultrasound apparatus for acquiring the image data.

13. A method of rendering image data representative of a structure, the method comprising:
processing data representative of the configuration of the structure;
rendering a display comprising a structure image representative of the structure and, a plurality of key data indicia relating to key data of the structure;
targeting key data indicium causing the structure image to display a highlight image of the structure related to the targeted indicium.

14. A method of imaging a structure comprising:
rendering a display having a structure image representative of the structure and a plurality of key data indicia, relating to key data of the structure;
targeting key data indicium causing the structure image to display a highlight image of the structure related to the targeted indicium.

15. A method according to claim 13 or claim 14, wherein the structure is heart LV.

16. A computer program product comprising a set of instructions for carrying out a method according to claim 13, 14 or 15.
